(19) United States
(12) Patent Application Publication
(10) Pub. No.: US 2018/0142555 A1
(43) Pub. Date: May 24, 2018

(54) REACTION-TYPE STEAM TURBINE

(71) Applicants: Sanghoon Lee, Seoul (KR); Jeajun Lee, Seoul (KR); Ju Chang Lim, Seo-gu (KR); Sang Myeong Lee, Seongnam-si (KR); Sungkeun Oh, Seo-gu (KR)

(72) Inventors: Sanghoon Lee, Seoul (KR); Jeajun Lee, Seoul (KR); Ju Chang Lim, Seo-gu (KR); Sang Myeong Lee, Seongnam-si (KR); Sungkeun Oh, Seo-gu (KR)

(73) Assignee: POSCO ENERGY CO., LTD., Seoul (KR)

(21) Appl. No.: 15/864,820

(22) Filed: Jan. 8, 2018

Related U.S. Application Data
(63) Continuation of application No. PCT/KR2016/005227, filed on May 18, 2016.

(30) Foreign Application Priority Data
Jul. 10, 2015 (KR) 10-2015-0098508

(51) Int. Cl. F01D 1/32; F01D 1/34; F01D 9/02

(52) U.S. Cl. CPC F01D 1/32; F05D 2220/31; F01D 9/02; F01D 1/34

(57) ABSTRACT

Embodiments of the present invention relate to a steam turbine in which unnecessary axial force is reduced. The steam turbine is capable of preventing a working fluid discharged from each nozzle-equipped rotary body from acting as resistance to the nozzle-equipped rotary bodies. The steam turbine includes a housing, a turbine shaft supported pivotably in the housing, a nozzle-equipped rotary body, and a guide panel. The nozzle-equipped rotary body is in the shape of a plurality of disks stacked along the axial direction of the turbine shaft, is integrally coupled to the turbine shaft, and has at least one or more nozzle holes formed therein so as to rotate as the working fluid is ejected. The guide panel is positioned at the rear end in a flow direction of the working fluid of the nozzle-equipped rotary body and fixed to the housing to guide the flow of the working fluid.

### CROSS-REFERENCE TO RELATED PATENT APPLICATIONS

This patent application is a continuation of PCT/KR2016/005227, filed May 18, 2016, which claims priority to Korean Application No. 10-2015-0098508, filed Jul. 10, 2015, the entire teachings and disclosure of which are incorporated herein by reference thereto.

### FIELD OF THE INVENTION

The present invention relates to a steam turbine, in particular to a steam turbine reducing unnecessary axial force, which can affect a turbine shaft transmitting the rotational driving force of a plurality of nozzle-equipped rotary bodies connected in multiple stages, and capable of preventing an working fluid discharged from each nozzle-equipped rotary body from acting as resistance to the nozzle-equipped rotary bodies.

### BACKGROUND OF THE INVENTION

A reaction-type steam turbine obtains the rotational energy by reaction of the discharged steam energy, so that high heat efficiency can be obtained with a simple structure. Accordingly, it is suitable as an engine with a small and medium capacity.

For example, a reaction-type turbine device is shown in Korean Patent Publication No. 10-2012-0047709 (Published Date: May 14, 2012), Korean Patent Publication No. 10-2013-0042250 (Published Date: Apr. 26, 2013) and Korean Patent No. 10-1229575 (Registration Date: Jan. 29, 2013).

FIG. 1 is a partly sectional schematic view of a reaction-type steam turbine according to a conventional art.

Referring to FIG. 1, the steam turbine comprises a plurality of nozzle-equipped rotary bodies 20 for ejecting an working fluid in a tangential direction with respect to a turbine shaft 10, and a housing 30 for supporting pivotably the nozzle-equipped rotary body 20 and providing a flow path of the working fluid so as to drive the nozzle-equipped rotary body 20 rotationally by the working fluid.

A plurality of nozzle-equipped rotary bodies 20 are spaced apart from one another along the turbine shaft 10 and composed of multiple stages. And each of the nozzle-equipped rotary body 20 is composed of a pair of disks, a fluid inlet that is disposed at one end thereof in an axial direction and through which the working fluid is introduced, and a plurality of nozzle holes so that the working fluid is ejected in a tangential direction along an exhaust flow-path formed inside the pair of disks.

The housing 30 comprises a substantially cylindrical body portion 31, an inlet 32 that is provided at a first side of the body portion 31 and through which the working fluid is introduced, an outlet 33 provided at a second side, opposite to the first side, of the body portion 31 such that the working fluid is discharged, and a barrier wall 34 positioned between each nozzle-equipped rotary body 20 on the inner circumferential surface of the body portion 31.

The housing 30 is provided with a bearing 35 that pivotably supports the turbine shaft 10.

FIG. 2 is a cross-sectional view of the conventional steam turbine, in which the working fluid (i.e. steam) is supplied from the right side, introduced into a nozzle-equipped rotary body through a center portion of the nozzle-equipped rotary body 20, ejected through a nozzle hole formed in a tangential direction of the outer circumferential surface of the nozzle-equipped rotary body 20, and introduced into another nozzle-equipped rotary body arranged at the next stage, thereby rotating the nozzle-equipped rotary body 20 at each stage.

The reaction-type steam turbine thus configured accelerates the working fluid introduced into the nozzle-equipped rotary body through the nozzle hole and ejects the working fluid to the outside to obtain the rotational force of the nozzle-equipped rotary body by the reaction force. In order to maximize the performance, the nozzle hole and the inside of the nozzle-equipped rotary body must be designed in the optimal shape in accordance with inflow conditions and desired outflow conditions of the working liquid. Especially in order to recover the heat/flow energy of the working fluid in turn, the nozzle of the nozzle-equipped rotary body needs to be designed using the governing equations of compressible flow so that the speed at the exit can be close to the supersonic speed.

On the other hand, the nozzle-equipped rotary body optimized to meet these conditions results in a large pressure difference between the inside and the outside of the nozzle-equipped rotary body, and the strong axial force in a single direction to the turbine shaft is generated due to the pressure difference.

Such an occurred axial force may increase the mechanical load of the bearings, which may cause performance degradation and life span reduction, and cause the operation costs to increase due to the deterioration of the turbine performance and frequent maintenance. As illustrated in FIG. 3, since the rotational direction A of the nozzle-equipped rotary body 20 and the flow direction B of the working fluid are opposite to each other due to the characteristics of the reaction-type steam turbine, the working fluid discharged from the nozzle-equipped rotary body 20, when the high-speed working fluid discharged from the rear end of the nozzle-equipped rotary body directly contacts the nozzle-equipped rotary body 20, the rotation of the nozzle-equipped rotary body 20 is interrupted, and as a result, the working fluid acts as resistance body to the nozzle-equipped rotary body 20.

FIG. 4 is a cross-sectional view for explaining the operation of an axial force of a steam turbine according to the conventional art.

The order as Ps1>Ps2>Ps4 Ps5>>Ps7>Ps8>>Ps6 Ps3 is obtained by roughly comparing the static pressure (Ps) at each flow-path point of the working fluid in FIG. 4.

Since the working fluid pressure inside the nozzle-equipped rotary body 20 is reduced only by the flow friction, the pressure difference at each point inside the nozzle-equipped rotary body 20 is relatively less varied. Slight loss of static pressure is caused by the friction while the working fluid moves from the inlet 20a to a nozzle hole 20b. On the other hand, the working fluid passing through the nozzle hole 20b has a drastic pressure drop phenomenon (point No. 6) as the velocity increases, and the working fluid pressure is recovered at a certain as the fluid velocity decreases while moving outside the nozzle-equipped rotatory body 20, (points NO. 7 and 8). Finally, since the flow is stagnant at point No. 3, the static pressures of No. 6 and No. 3 can be regarded to be almost the same. When the fluid pressure distribution is famed inside/outside the nozzle-equipped rotary body 20, the distributions of forces F1, F2, F3 generated at the wall surfaces z1, z2, z3 of the nozzle-equipped rotary body 20 can be expressed by the pressure difference at each point and the area of the surface of the wall of the nozzle-equipped rotary body as shown in the following [Equation 1].

F1=(Ps2−Ps8)×A_z1,

F2=(Ps5−Ps7)×A_z2,

F3=(Ps4−Ps3)×A_z3, [Equation 1]

In the above equation, A is the area of each wall surface z1, z2, z3.

In addition, the force Ft that appears throughout one nozzle-equipped rotatory body 21 can be expressed by the following [Equation 2].

Ft=F3−F1−F2 [Equation 2]

Since the pressure difference per each point is not uniform and the areas of the wall surface of the nozzle-equipped rotary body are different from one other, the force Ft generated in the nozzle-equipped rotary body 20 as a whole does not become ‘0’. The force generated from each nozzle-equipped rotary body is transmitted to the turbine shaft 10 and appears as a unidirectional axial force.

Accordingly, the present invention has been made in order to solve the problems of the conventional art, and provide a steam turbine reducing unnecessary axial force, which can affect a turbine shaft transmitting the rotational driving force of a plurality of nozzle-equipped rotary bodies connected in multiple stages and capable of preventing an working fluid discharged from each nozzle-equipped rotary body from acting as resistance to the nozzle-equipped rotary bodies.

### BRIEF SUMMARY OF THE INVENTION

In order to accomplish the above objects, the present invention provides a steam turbine including a housing; a turbine shaft supported pivotably in the housing; a nozzle-equipped rotary body in the shape of a plurality of disks stacked along the axial direction of the turbine shaft, being integrally coupled to the turbine shaft and having at least one or more nozzle holes formed therein so as to rotate as the working fluid is ejected; and a guide panel positioned at the rear end in a flow direction of the working fluid of the nozzle-equipped rotary body and fixed to the housing to guide the flow of the working fluid.

Preferably, the guide panel includes a panel body having a shaft hole for allowing the turbine shaft to pass therethrough and be positioned therein; and a fixing protrusion protruding from the rim of the panel body and fixed to the inside of the housing.

More preferably, the panel body is equal to or smaller than the diameter of the nozzle-equipped rotary body located at the front end in a flow direction of the working fluid.

Preferably, the guide panel is disposed more adjacent to a nozzle-equipped rotary body positioned at a front end in the direction of the working fluid flow among two neighboring nozzle-equipped rotary bodies.

According to the present invention, the steam turbine includes a guide panel at each rear end of a plurality of nozzle-equipped rotary bodies composed of multiple stages to minimize the friction loss that may be generated when the ejected working fluid comes into contact with the nozzle-equipped rotary body, thereby vibration/fatigue problems caused by stress generation can be minimized by reducing the load in the axial directional with regards to the turbine shaft and the life span of bearing elements can be extended.

### BRIEF SUMMARY OF THE SEVERAL VIEWS OF THE DRAWING

FIG. 1 is a partly sectional schematic view of a steam turbine according to a conventional art;

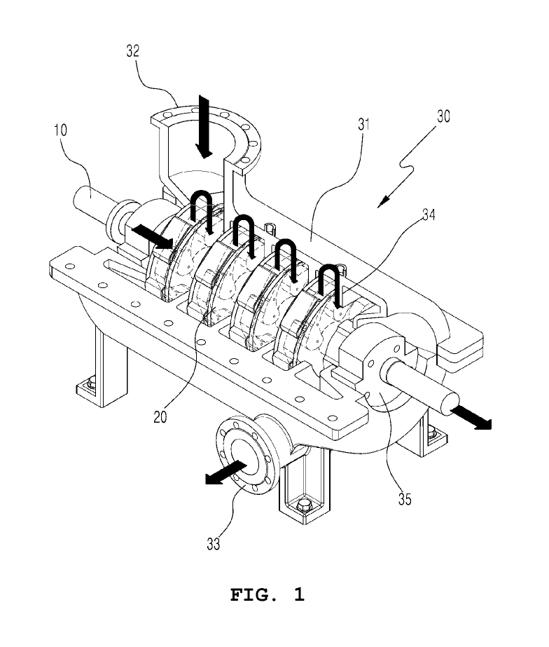

FIG. 2 is a cross-sectional structural view of a part of a steam turbine of the conventional art;

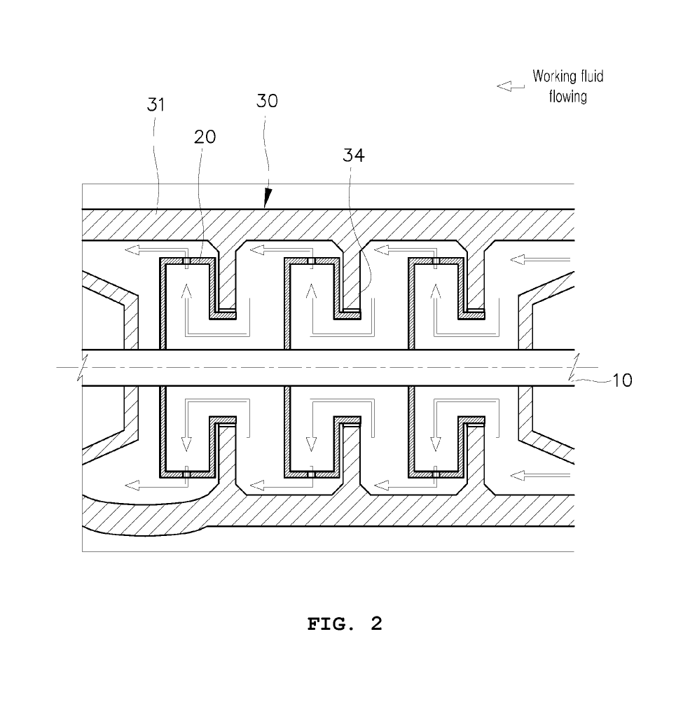

FIG. 3 is a view showing an operation flow of a nozzle-equipped rotary body and a working fluid of a steam turbine according to the conventional art;

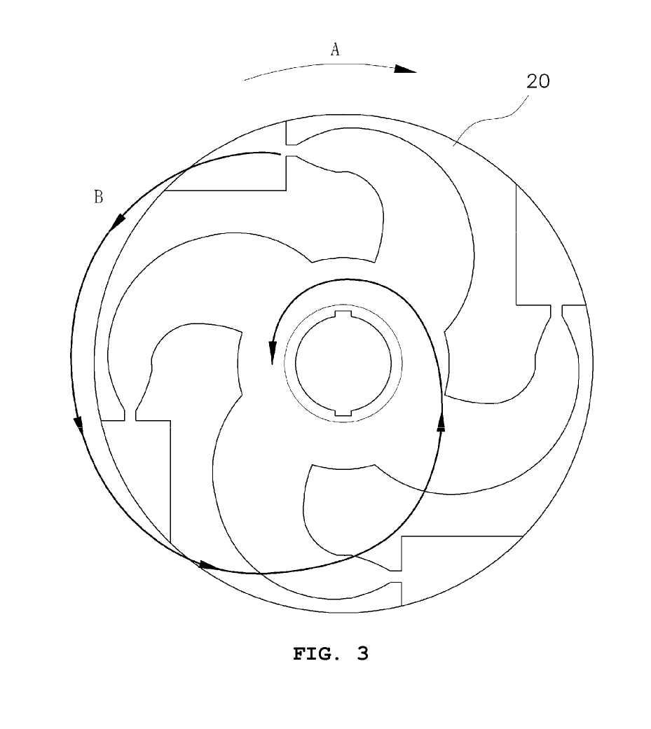

FIG. 4 is a cross-sectional view for explaining an operation of an axial force of a steam turbine according to the conventional art;

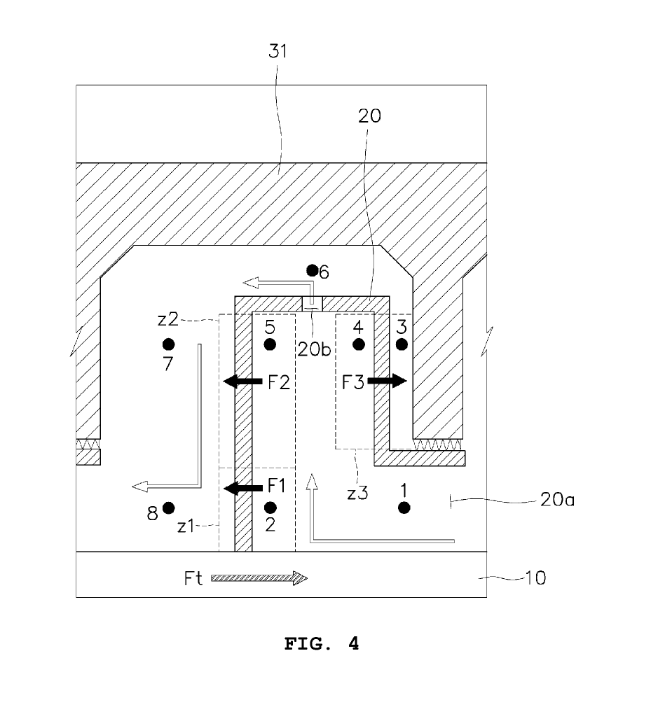

FIG. 5 is a cross-sectional view showing a configuration of a main part of a steam turbine according to the present invention;

FIG. 6 is a plan view of the guide panel of the present invention; and

FIG. 7 is a cross-sectional view for explaining an output operation of the steam turbine according to the present invention.

### DESCRIPTION OF THE REFERENCE NUMERALS IN THE DRAWINGS

110: housing

120: turbine shaft

130: nozzle-equipped rotary body

131: inlet

132: nozzle hole

140: guide panel

### DETAILED DESCRIPTION OF THE INVENTION

The specific structure or functional description presented in the embodiments of the present invention is merely illustrative for the purpose of describing an embodiment according to the concept of the present invention, and embodiments according to the concept of the present invention may be embodied in various forms. And the present invention should not be construed as limited to the embodiments set forth herein, but should be understood to include all modifications, equivalents, and alternatives falling within the spirit and scope of the invention.

On the other hand, in the present invention, the terms first and/or second etc. may be used to describe various components, but the components are not limited to the terms. For example, the term, a first component may be referred to as a second component since the terms are defined only for the purpose of distinguishing one component from another component to the extent not departing from the scope of the invention in accordance with the concept of the present invention. Similarly, the second component may also be referred to as a first component.

It is to be understood that when an element is referred to as being “connected” or “accessed” to another element, it may be directly connected or accessed to the other element, but it should be understood that other elements may be present in between. On the other hand, when it is mentioned that an element is directly connected or directly accessed to the other element, it should be understood that there are no other elements in between. Other expressions for describing the relationship between components, such as “between” and “directly between” or “adjacent to” and “directly adjacent to” should also be interpreted likewise.

The terminology used herein is for the purpose of describing particular embodiments only and is not intended to limit the invention. The singular forms include plural expressions in meaning unless the context clearly dictates otherwise. It is to be understood that the terms “include” or “have” and the like in the specification are intended to specify the presence of stated implemented features, numbers, steps, operations, elements, parts, or combinations thereof. However, it does not preclude the presence or potential addition of one or more other features, numbers, steps, operations, elements, parts, or combinations thereof.

Hereinafter, embodiments of the present invention will be described in detail with reference to the accompanying drawings.

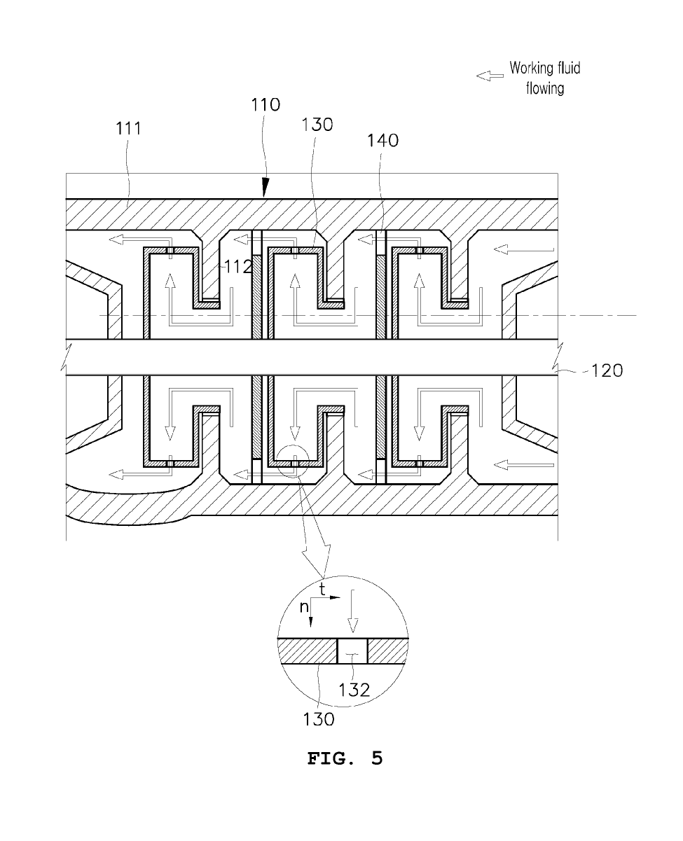

FIG. 5 is a schematic view of a main part of a steam turbine according to the present invention. In order to facilitate understanding, it is assumed that the working fluid is introduced from the right side, passes through each nozzle-equipped rotary body, and then is exhausted to the left side.

As illustrated in FIG. 5, the steam turbine of the present invention comprises a housing 110; a turbine shaft 120 supported pivotably in the housing 110; a nozzle-equipped rotary body 130 in the shape of a plurality of disks stacked along the axial direction of the turbine shaft 120, integrally coupled to the turbine shaft 120 and having at least one or more nozzle holes 132 formed therein so as to rotate as the working fluid is ejected; and a guide panel 140 positioned at the rear end in a flow direction of the working fluid of the nozzle-equipped rotary body and fixed to the housing 110 to guide the flow of the working fluid.

The housing 110 comprises a body portion 111, and a barrier wall 112 extending inwardly integrally from the body portion 111 to partition each nozzle-equipped rotary body 130, and the working fluid discharged from each nozzle-equipped rotary body 130 induces the flow of the working fluid to the center of the nozzle-equipped rotary body at the next stage along the barrier wall 112. Although not illustrated in drawings, the turbine shaft 120 is pivotably supported by a bearing in the housing 110.

The nozzle hole 132 is formed on the outer circumferential surface of the nozzle-equipped rotary body 130 and the nozzle hole 132 is formed in the direction of the normal line (n) of the outer circumferential surface in the present embodiment, but may be formed with an inclination in the flow direction of the working fluid.

The guide panel 140 is positioned at the rear end in the flow direction of the working fluid of each nozzle-equipped rotary body 130, and is fixed to the housing 110 to guide the flow of the working fluid.

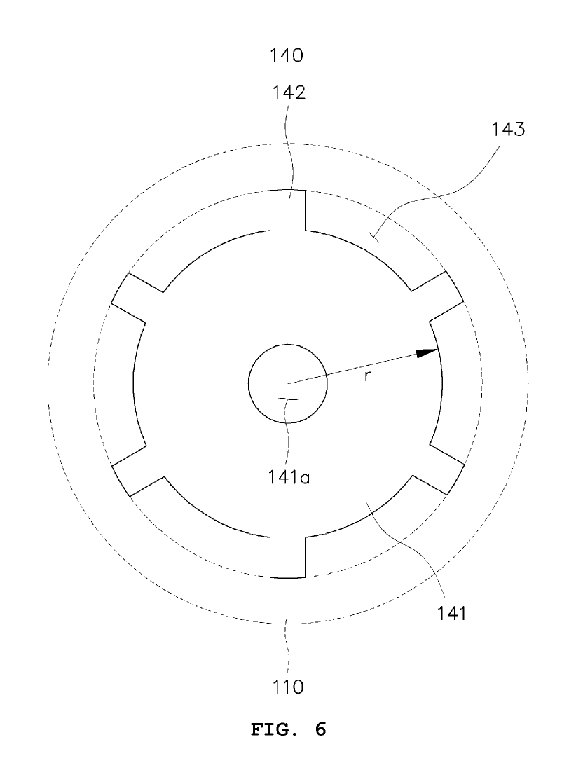

Specifically referring to FIG. 6, the guide panel 140 comprises a panel body 141 having a shaft hole 141a for allowing the turbine shaft to pass therethrough and be positioned therein; and a fixing protrusion 142 protruding from the rim of the panel body 141 and fixed to the inside of the housing 110.

The panel body 141 is in the shape of a circular disk, and a shaft hole 141a is formed in the center. Accordingly, the turbine shaft 120 passes through the shaft hole 141a and is positioned therein.

Preferably, the diameter 2r of the panel body 141 is at least equal to or smaller than that of the nozzle-equipped rotary body that is located at the front end in the flow direction of the working fluid.

The size of the panel body 141 can be determined in consideration of the separated distance from the nozzle-equipped rotary body located at the front end. Since the working fluid ejected from the nozzle-equipped rotary body is moved to the nozzle-equipped rotary body at the next stage by the guide panel 140 positioned at the rear end, it does not act as resistance to the nozzle-equipped rotary body.

The fixing protrusion 142 protrudes radially from the rim of the panel body 141 and is fixed to the inner circumferential surface of the housing 110. The fixing protrusion 142 may be fixed to the housing by welding, or a groove may be formed in the housing such that the fixing protrusion is inserted and fixed.

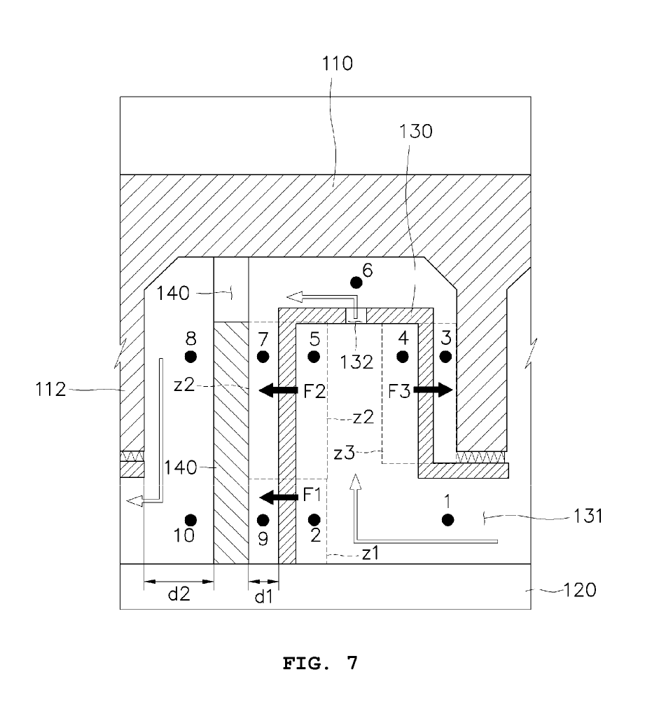

FIG. 7 is a cross-sectional view for explaining the operation of the steam turbine according to the present invention.

As illustrated in FIG. 7, the guide panel 140 is disposed more adjacent to the nozzle-equipped rotary body located at the front end in the flow direction of the working fluid among two neighboring nozzle-equipped rotary bodies (d1<d2). Accordingly, most of the working fluid ejected from the nozzle-equipped rotary body 130 moves to a space between the barrier wall 112 and the guide panel 130 to reduce the friction loss due to the flow with the corresponding nozzle-equipped rotary body 130.

Referring to FIG. 7, the points of flow path affecting the surface of a wall of the nozzle-equipped rotary body 130 are 1, 2, 3, 4, 5, 7, and 9, and the static pressure of the fluid at points 8 and 10 through which most of the working fluid passes is irrelevant to the nozzle-equipped rotary body 130 due to the guide panel 140 fixed to the housing 110.

In addition, the amount of the working fluid flowing into the space between the nozzle-equipped rotary body 130 and the guide panel 140 can be adjusted appropriately according to the installation position of the guide panel 140 (the separated distance from the nozzle-equipped rotary body) Accordingly, the guide panel 140 is fixedly installed at a position where the thrust of the turbine shaft 120 can be minimized by calculating the thrust direction and the magnitude (Ft: the resultant force of F1, F2, and F3) of the nozzle-equipped rotary body 130.

Further, according to the present invention, the working fluid ejected from the nozzle-equipped rotary body 130 blocks contact with the nozzle-equipped rotary body 130 to minimize the friction loss due to the flow, thereby reducing unnecessary load of the axial force on the turbine shaft. Accordingly, the load in the axial direction of the bearing element supporting the turbine shaft is decreased to minimize life-span reduction due to the mechanical loss of the bearing element.

On the other hand, the ejecting powers of the working fluid of the nozzle-equipped rotary body composed of multiple stages are not substantively identical to one another. Accordingly, the separated distance between the nozzle-equipped rotary body and the guide panel disposed at the rear end of each nozzle-equipped rotary body may be different from one another by reflecting the ejecting power of each nozzle-equipped rotary body.

It will be apparent to those skilled in the art that various modifications and variations can be made in the present invention without departing from the spirit or scope of the general inventive concept as defined by the following claims.

1. A steam turbine, comprising:
a housing;
a turbine shaft supported pivotably in the housing;
a nozzle-equipped rotary body in the shape of a plurality of disks stacked along the axial direction of the turbine shaft, being integrally coupled to the turbine shaft and having at least one or more nozzle holes formed therein so as to rotate as the working fluid is ejected and; and
a guide panel positioned at the rear end in the flow direction of the working fluid of the nozzle-equipped rotary body and fixed to the housing to guide the flow of the working fluid.

2. The steam turbine according to claim 1,
wherein the guide panel comprises a panel body having a shaft hole for allowing the turbine shaft to pass therethrough and be positioned therein; and a fixing protrusion protruding from the rim of the panel body and fixed to the inside of the housing.

3. The steam turbine according to claim 2,
wherein the panel body is equal to or smaller than the diameter of the nozzle-equipped rotary body located at the front end in a flow direction of the working fluid.

4. The steam turbine according to claim 1,
wherein the guide panel is disposed closer to the nozzle-equipped rotary body located at the front end in the flow direction of the working fluid among two neighboring nozzle-equipped rotary bodies.

5. The steam turbine according to claim 2,
wherein the guide panel is disposed closer to the nozzle-equipped rotary body located at the front end in the flow direction of the working fluid among two neighboring nozzle-equipped rotary bodies.

6. The steam turbine according to any one of claim 3,
wherein the guide panel is disposed closer to the nozzle-equipped rotary body located at the front end in the flow direction of the working fluid among two neighboring nozzle-equipped rotary bodies.
